(19) United States
(12) Patent Application Publication
(10) Pub. No.: US 2008/0243852 A1
(43) Pub. Date: Oct. 2, 2008

(54) System and Methods for Enabling Collaboration in Online Enterprise Applications

(75) Inventors: Robi Brunner, Wallingford, CT (US); Soobaek Jang, Hamden, CT (US); Konrad Lagarde, Milford, CT (US); Kelly Samardak, New York, NY (US)

Correspondence Address: CAHN & SAMUELS, LLP, 1100 17th STREET, NW, SUITE 401, WASHINGTON, DC, 20036, US

(73) Assignee: INTERNATIONAL BUSINESS MACHINES CORPORATION, Armonk, NY (US)

(21) Appl. No.: 11/691,264

(22) Filed: Mar. 26, 2007

(51) Int. Cl. G06F 17/30

(52) U.S. Cl. 707/9; 707/E17.005

(57) ABSTRACT

A method for enabling collaboration in online enterprise applications includes, during development of the online enterprise application, selecting at least one webpage to be in wiki format; creating an access control list for the at least one webpage; and selecting at least one control for the at least one webpage. The at least one webpage may be edited directly within the online enterprise application. A system for enabling collaboration in online enterprise applications includes an agent for allowing selection and setup of at least one webpage in wiki format during development of an online enterprise application and a database for storing editable content of the at least one webpage in wiki format.

### I. FIELD OF THE INVENTION

This invention relates to a system and methods for enabling collaboration in online enterprise applications using a wiki.

### II. BACKGROUND OF THE INVENTION

A “wiki” is a type of website or webpage that allows visitors to easily add, remove, and otherwise edit and change some available content. The term “wiki” may also refer to the collaborative software and tools that facilitate the operation of such a website. The ease of interaction and operation makes a wiki an effective tool for collaborative authoring. For example, the world's largest wiki is the online encyclopedia Wikipedia.

A wiki works by enabling content to be written in a simple markup language using a web browser. Users are not required to know hypertext markup language (HTML) to add or edit content of a website or webpage. The reasoning behind this design is that HTML, with its many cryptic tags, is not especially human-readable and therefore is difficult to edit. In contrast, by using a simplified markup language to indicate a few structural, style, and visual conventions, a wiki promotes plain-text editing.

A main purpose of a wiki is its role as an information hub where users contribute information regarding a defined topic in a continuing cycle of revision and update, thereby enhancing the distribution of the latest knowledge. Thus, with the participation of casual contributors and/or subject matter experts (SME), a wiki can quickly become the single most relevant and up-to-date source of information available.

A current problem with the wiki concept is that it does not work well when combined with online enterprise applications (OEA). For example, if an OEA wants to use a wiki for a Frequently Asked Questions (FAQ) page, the OEA must pull the editable content from a separate wiki application to the OEA's FAQ page. This scenario renders a read-only FAQ page within the OEA. In addition, if a user wants to contribute information to a FAQ page, the user must go to the separate wiki application, login, and edit the content so that the FAQ page will be rendered with the latest update.

This process creates a disadvantageous experience issue for users. Once a user is sent to a separate wiki application, the user interface will be different from that of the OEA. Thus, the user has to negotiate a completely different application experience and to learn new layouts, which can lead to a lengthy learning curve and subsequent confusion.

### Ill. SUMMARY OF THE INVENTION

According to an aspect of the invention, a method is provided for enabling collaboration in online enterprise applications. During development of an online enterprise application, at least one webpage is selected to be in wiki format. At least one access control list for the at least one webpage is created. At least one control for the at least one webpage is selected. The at least one webpage may be edited directly within the online enterprise application.

According to another aspect of the invention, a method is provided for collaborating in an online enterprise application. An online enterprise application is accessed. At least one webpage of the online enterprise application is viewed in wiki format if authorized by an access control list. At least one control for the at least one webpage is selected. The at least one webpage is edited within the online enterprise application. The at least one webpage in wiki format has the same user interface as other webpages in the online enterprise application.

According to another aspect of the invention, a system is provided for enabling collaboration in online enterprise applications. The system includes an agent for allowing selection and setup of at least one webpage in wiki format during development of an online enterprise application and a database for storing editable content of the at least one webpage in wiki format.

According to another aspect of the invention, a computer program product is provided comprising a computer useable medium having a computer readable program. When executed on a computer, the computer readable program causes the computer to select at least one webpage to be in wiki format; create an access control list for the at least one webpage; and select at least one control for the at least one webpage. The at least one webpage may be edited directly within the online enterprise application.

### IV. BRIEF DESCRIPTION OF THE DRAWINGS

FIG. 1 is a schematic diagram of a method for editing a webpage of an online enterprise application using a wiki according to the prior art.

FIG. 2 is a schematic diagram of a method for editing a webpage of an online enterprise application using a wiki according to the present invention.

FIG. 3 is a flowchart of a method for creating an online enterprise application according to an embodiment of the present invention.

FIG. 4 illustrates how an online enterprise application is viewed by a user according to the present invention.

FIG. 5 is a system according to an embodiment of the present invention.

FIG. 6 is an agent according to an embodiment of the present invention.

### V. DETAILED DESCRIPTION OF THE DRAWINGS

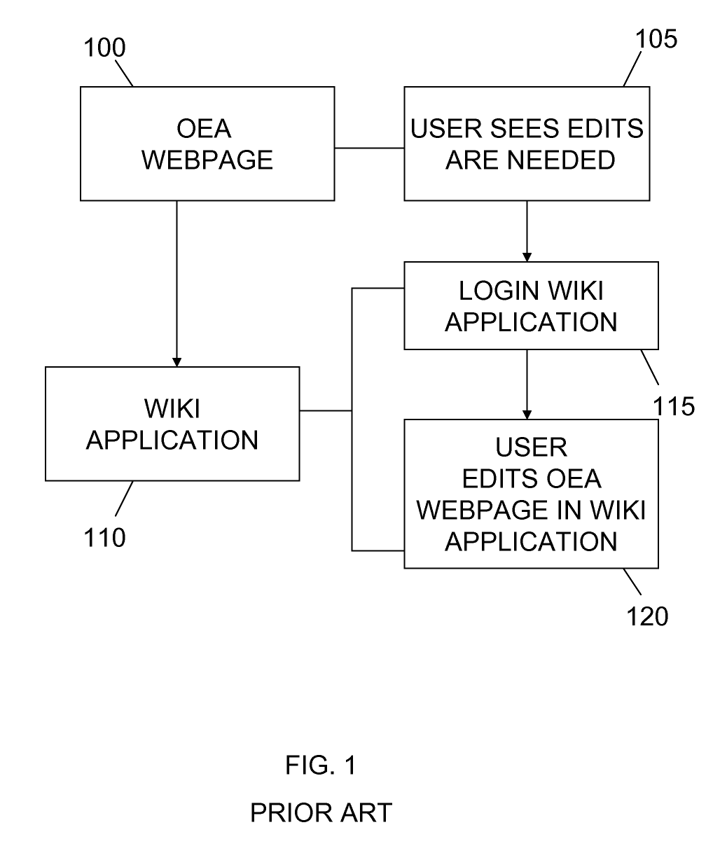

As shown in FIGS. 1-6, the invention is directed to a system and methods for enabling collaboration in online enterprise applications using a wiki.

In this detailed description, references to “one embodiment”, “an embodiment”, or “in embodiments” mean that the feature being referred to is included in at least one embodiment of the invention. Moreover, separate references to “one embodiment”, “an embodiment”, or “embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

An OEA is any application using the internet or world wide web and which has both static content and dynamic content. The dynamic content results from user action or user configuration and can only be seen by the user. For example, online shopping sites, such as Amazon®, have static content regarding goods for sale and dynamic content that only the user can see, such as shopping carts, wish lists, user profiles, and purchasing information.

It is desirable to integrate a wiki into OEAs, for example, for webpages directed to online documentation or publishing. In particular, it is desirable to use a wiki in an OEA for at least one of product support, help, frequently asked questions (FAQ), product documentation, user guides, or product feedback. By using a wiki, such webpages of an OEA would contain the most up-to-date information.

Currently, however, the wiki concept does not work well when combined with an OEA, as shown in FIG. 1. For example, a user views an OEA webpage 100 (e.g., a FAQ page) and sees that edits to the webpage are needed, 105. The user must go to a separate wiki application 110, which may reside on the same server or a different server than the OEA. The user must login to the wiki application 115 and edit the content of the OEA webpage in the wiki application, 120. The OEA pulls the edited content from the separate wiki application 110 to the OEA webpage 100. This scenario renders a read-only webpage for the OEA. The user interface and general experience of using the wiki application will be different from the OEA. Thus, the user has to negotiate a completely different application experience and to learn new layouts.

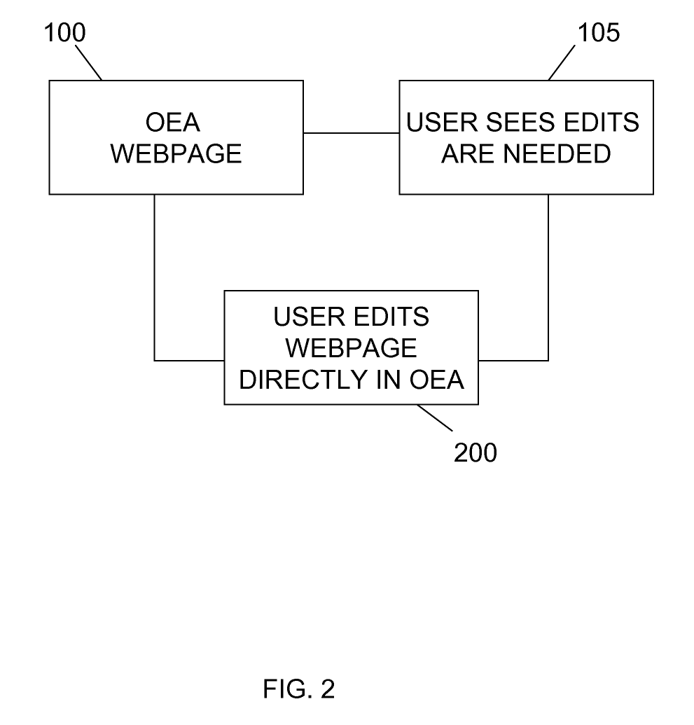

According to the present invention, a wiki is seamlessly integrated directly into an OEA. As shown in FIG. 2, a user views an OEA webpage 100 (e.g., a FAQ page) and sees that edits to webpage are needed, 105. The user is able to edit the webpage directly within the OEA, 200. Thus, as far as users are concerned, they stay completely in the scope of the OEA. Users can easily and directly update the OEA webpage 100 without the perception of being sent to a different wiki application and having to negotiate a completely different user interface. The user interface and the controls to edit the OEA webpage 100 will be consistent with the look, feel, and experience of the overall OEA. Accordingly, an OEA hosts wiki-style pages.

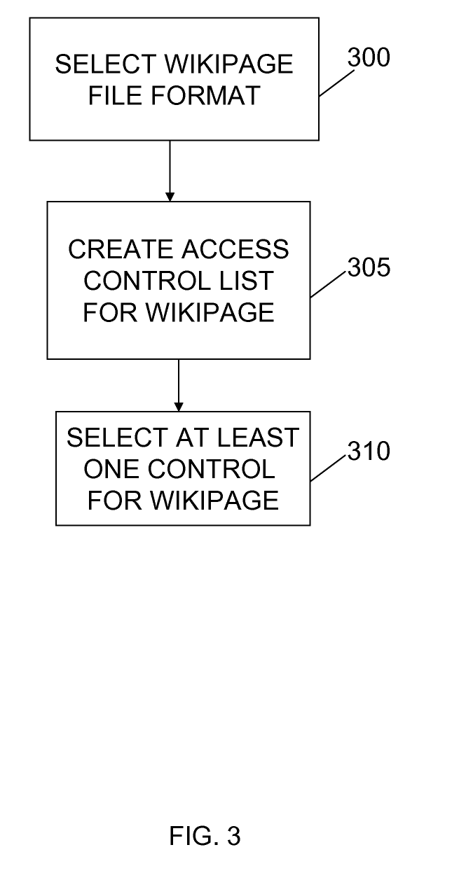

The seamless integration of OEA and a wiki may be achieved during the development of an OEA according to the present invention, as shown by the exemplary method illustrated in FIG. 3.

During typical development of an OEA, when developers create a new webpage, they select the type of the file, such as hypertext markup language (HTML, XHTML), java server pages (JSP), cascading style sheets (CSS), and the like. According to the present invention, developers of an OEA may select at least one webpage to be in wiki format by selecting a file format called a wikipage, 300. Thus, the wikipage is integrated into the same application as the OEA. The editable content of the wikipage is automatically stored in a database.

Developers define the look, feel, and layout of a wikipage, just like any other page in an OEA, except that the information for the wikipage is in wiki format (e.g., a simplified markup language). In embodiments, developers may select at least one field, for example two or more fields, of the wikipage to be in wiki format, thereby allowing the at least one field to be editable directly within the OEA. The information entered in wiki format is automatically stored in a database.

As shown in FIG. 3, developers may create at least one access control list to associate a wikipage with at least one of individual users or groups, 305. In embodiments, an access control list may include at least one individual, for example, a president, human resources administrator, system administrator, accountant, team leader, an expert, or any combination thereof. Similarly, an access control list may include at least one group, for example, employees, corporate officers, vendors, corporate departments, team members, government agencies, subject matter experts, or combinations thereof. In embodiments, users on the access control list may require a special registration or log-in for the OEA.

In embodiments, developers may use an access control list to provide a level of security for the OEA. Thus, wikipage access controls may be based on the same list or lists used for online enterprise application security. Consequently, the OEA does not have to rely on a separate application or server to determine security clearance.

In embodiments, developers may use an access control list to assign certain rights to at least one of an individual user or group. For example, an individual user or group may be assigned at least one of writing a webpage, reviewing a webpage, editing a webpage, or reverting a webpage to a previous version.

Based upon the at least one access control list, a permission management page may be automatically created, so that the at least one access control list may be modified directly online without having to recreate the wikipage or redeploy any code. For example, an individual such as a system administrator may be selected who would have access to the permission management page. In embodiments, the permission management page may be accessed directly via the wikipage.

As shown in FIG. 3, developers may select at least one control for the wikipage, 310. In embodiments, the wikipage will have at least one control including, but not limited to, Edit, Recent Changes, History, Watchlist, Add Attachments, or any combination thereof. The Edit control allows a user to edit content of the wikipage. The Recent Changes control displays a list of recent edits within a predetermined timeframe and indicates who made the edits. The History control shows previous wikipage versions. Using the History control, a user can view and restore previous versions of the wikipage. The Watchlist control allows a user to be notified, for example by e-mail, every time an edit or change is made to a wikipage. The Add Attachments control allows a user to add at least one of pictures, movies, music, documents, spreadsheets, e-mails, or other files to the wikipage.

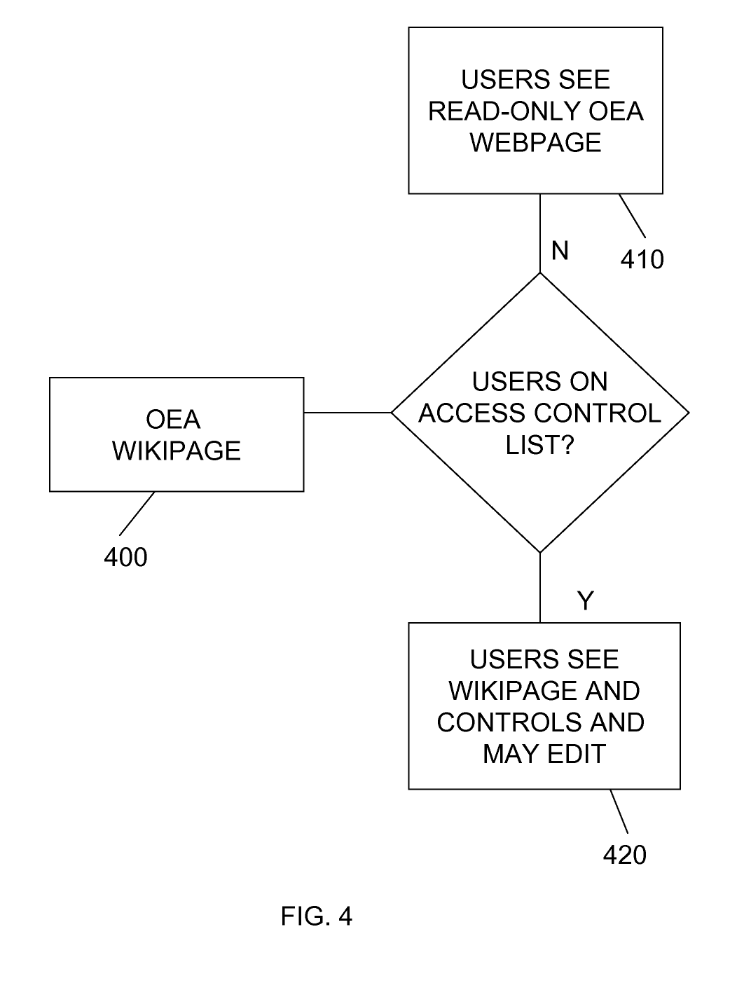

FIG. 4 illustrates how an OEA wikipage 400 may be viewed by a user according to an embodiment of the present invention. For users not on the access control list, users see the wikipage 400 as a regular webpage in read-only format, 410. For users on the access control list, the users see the wikipage as an editable webpage with assigned controls, 420. Thus, the user can edit the wikipage directly within the OEA.

Thus, according to the present invention a method for collaborating in an online enterprise application is provided which allows users to access an online enterprise application; view at least one webpage of the online enterprise application in wiki format if authorized by an access control list; select at least one control for the at least one webpage; and edit the at least one webpage within the online enterprise application. The at least one webpage in wiki format has the same user interface as other webpages in the online enterprise application.

An example of the use of a wikipage in an OEA according to the present invention includes, but is not limited to, a webpage reporting a cable or utility outage. The wikipage may have an access control list for customers or for repair crews. Instead of an employee at the cable or utility company having to centrally process incoming data received from customers or crews and then update a webpage, the wikipage can be easily, quickly, and more accurately updated by those customers and/or crews having firsthand knowledge of the cable or utility outage. Thus, the most up-to-date information of an outage is collaboratively shared.

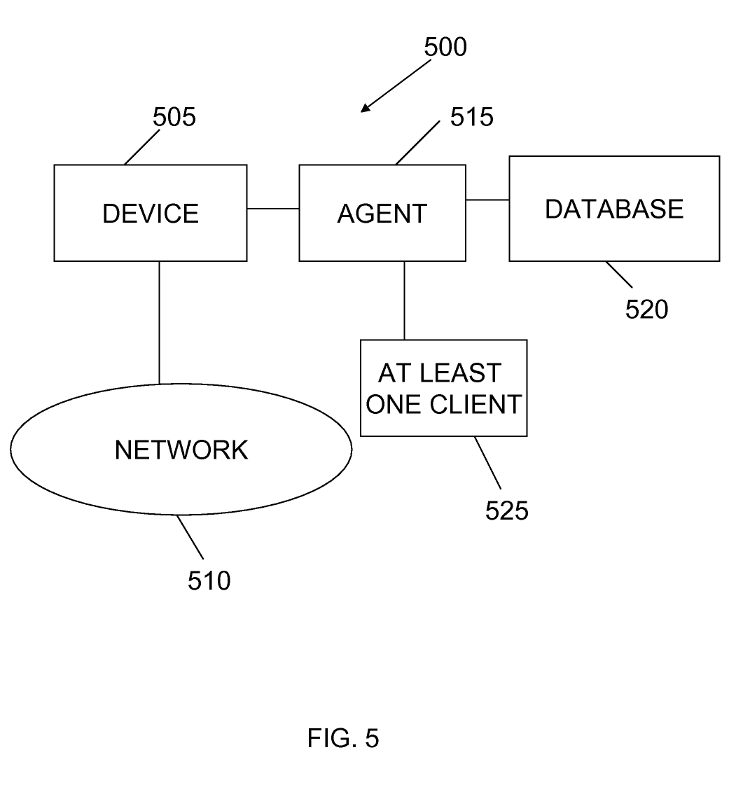

FIG. 5 is a block diagram showing an illustrative system of the invention, 500. The illustrative system includes at least one electronic or digital device 505 (e.g., a personal computer, cellular telephone, personal digital assistant or PDA, game device, MP3 player, television) to access a webpage. The at least one device may be connected to a network 510 (e.g., the internet, world wide web, local area network (LAN), wide area network (WAN)). In embodiments, the system includes an agent 515, comprising at least one client 525, for allowing selection and setup of at least one webpage in wiki format (wikipage) during development of an online enterprise application. The editable content of the wikipage may be stored in at least one database 520. The agent and at least one client may be applications residing on the at least one electronic or digital device. The illustrative system is but one example, and one of ordinary skill in the art would recognize that many other variations may exist, all of which are contemplated by the invention.

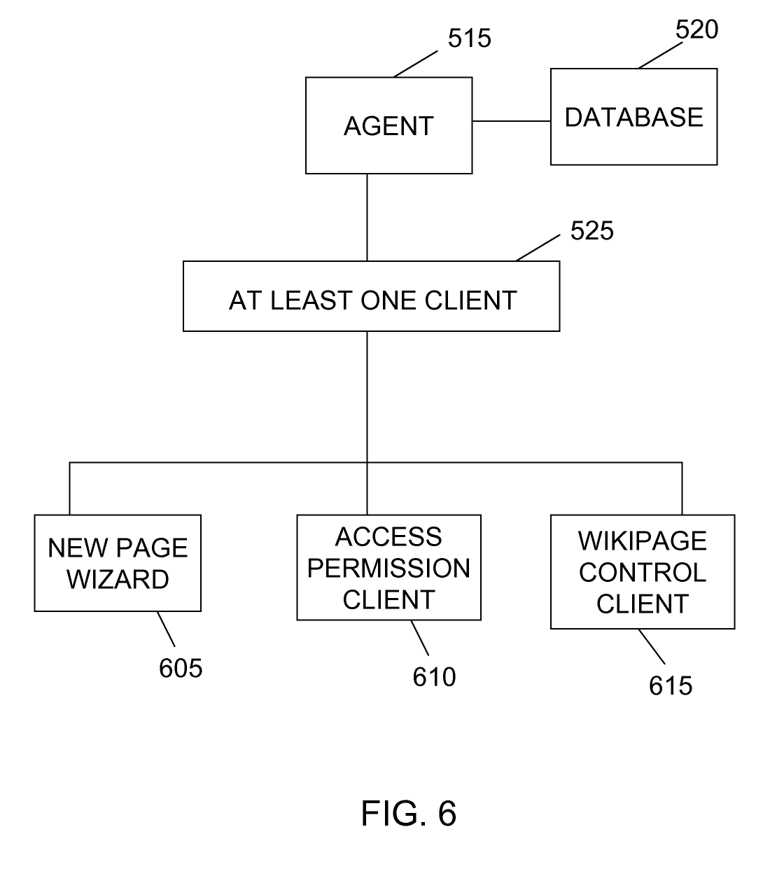

FIG. 6 illustrates an exemplary agent 515 of the invention which includes at least one client 525 comprising a new page wizard 605, an access permission client 610, a wikipage control client 615, or any combination thereof. In embodiments, the new page wizard 605 gives a developer a choice of formats for a creating new webpages of an OEA, including a wikipage. The new page wizard 605 automatically links the wikipage to the at least one database 520 and stores historical data for the editable content of the wikipage in the at least one database 520. In embodiments, the historical data may be in the form of tables and may contain a predetermined number of revisions of editable content. The access permission client 610 stores the users and/or groups of an access control list in the at least one database 520, for example, in the form of a permission table. In embodiments, the access permission client 610 creates a user interface that allows a developer or other party to manage an access control list for a wikipage online via a permission management page. The access permission client 610 may also assign specific rights for a wikipage to an individual and/or group. A wikipage control client 615 allows for the selection of different controls for a wikipage.

As illustrated in FIG. 3, a new page wizard allows a developer to select wikipage format for a webpage of an OEA. A permission control client stores a specified access control list for the wikipage and may assign rights for the wikipage. A wikipage control client provides different controls for the wikipage.

The seamless integration according to the present invention means that not only will the OEA be able to provide users with the easiest and most effective methods to contribute information to the OEA and keep the information up-to-date, but it also provides OEA owners, maintainers, and developers with a better single application maintenance and development model.

With the present invention, OEAs will offer both unprecedented user experiences for seamless application use and wiki-style collaboration as well as a tightly integrated development experience.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Computer program code for carrying out operations of the present invention may be written in a variety of computer programming languages. The program code may be executed entirely on at least one computing device, as a stand-alone software package, or it may be executed partly on one computing device and partly on a remote computer. In the latter scenario, the remote computer may be connected directly to the one computing device via a LAN or a WAN (for example, Intranet), or the connection may be made indirectly through an external computer (for example, through the Internet, a secure network, a sneaker net, or some combination of these).

It will be understood that each block of the flowchart illustrations and block diagrams and combinations of those blocks can be implemented by computer program instructions and/or means. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowcharts or block diagrams.

The exemplary and alternative embodiments described above may be combined in a variety of ways with each other. Furthermore, the steps and number of the various steps illustrated in the figures may be adjusted from that shown.

Although the present invention has been described in terms of particular exemplary and alternative embodiments, it is not limited to those embodiments. Alternative embodiments, examples, and modifications which would still be encompassed by the invention may be made by those skilled in the art, particularly in light of the foregoing teachings.

What is claimed is:

1. A method for enabling collaboration in online enterprise applications, comprising:
during development of the online enterprise application, selecting at least one webpage to be in wiki format;
creating at least one access control list for the at least one webpage; and
selecting at least one control for the at least one webpage, wherein the at least one webpage may be edited directly within the online enterprise application.

2. A method according to claim 1, comprising selecting at least one field of the at least one webpage to be in wiki format.

3. A method according to claim 1, wherein the at least one webpage in wiki format is at least one of product support, help, frequently asked questions, product documentation, user guides, or product feedback.

4. A method according to claim 1, wherein the at least one access control list comprises at least one of different users or groups.

5. A method according to claim 1, wherein the at least one access control list comprises at least one group comprising employees, corporate officers, vendors, corporate departments, team members, government agencies, subject matter experts, or combinations thereof.

6. A method according to claim 1, wherein the at least one access control list comprises at least one individual comprising a president, human resources administrator, system administrator, accountant, team leader, an expert, or any combination thereof.

7. A method according to claim 1, wherein the at least one access control list provides a level of security for the online enterprise application.

8. A method according to claim 1, wherein the wikipage is in read-only format for users not on the access control list and appears as an editable webpage for users on the access control list.

9. A method according to claim 1, further comprising automatically creating a permission management page so that the at least one access control list may be modified directly online.

10. A method according to claim 1, wherein users on the at least one access control list require a registration or log-in for the online enterprise application.

11. A method according to claim 1, wherein editable content of the at least one webpage is automatically stored in a database.

12. A method according to claim 1, further comprising assigning rights to the at least one webpage to at least one of an individual user or group using the at least one access control list.

13. A method according to claim 12, wherein the assigned rights comprise at least one of writing a webpage, reviewing a webpage, editing a webpage, or reverting a webpage to a previous version.

14. A method according to claim 1, wherein the at least one control comprises at least one of Edit, Recent Changes, History, Watchlist, Add Attachments, or any combination thereof.

15. A method for collaborating in an online enterprise application, comprising:
accessing an online enterprise application;
viewing at least one webpage of the online enterprise application in wiki format if authorized by an access control list;
selecting at least one control for the at least one webpage; and
editing the at least one webpage within the online enterprise application,
wherein the at least one webpage in wiki format has the same user interface as other webpages in the online enterprise application.

16. A system for enabling collaboration in online enterprise applications, comprising:
an agent for allowing selection and setup of at least one webpage in wiki format during development of an online enterprise application; and
a database for storing editable content of the at least one webpage in wiki format.

17. A system according to claim 16, wherein the agent comprises at least one client comprising a new page wizard, an access permission client, a wikipage control client, or any combination thereof.

18. A computer program product, comprising:
a computer useable medium having a computer readable program, wherein the computer readable program when executed on a computer causes the computer to:
select at least one webpage to be in wiki format;
create an access control list for the at least one webpage; and
select at least one control for the at least one webpage,
wherein the at least one webpage may be edited directly within the online enterprise application.
